(19) United States
(12) Patent Application Publication
(10) Pub. No.: US 2019/0247777 A1
(43) Pub. Date: Aug. 15, 2019

(54) Method and Apparatus for Providing Test Ports

(71) Applicant: American Air Filter Company, Inc., Louisville, KY (US)

(72) Inventor: Jorn Poulsen, Kuala Lumpur (MY)

(21) Appl. No.: 15/893,403

(22) Filed: Feb. 9, 2018

(51) Int. Cl. B01D 46/00; B01D 46/52

(52) U.S. Cl. CPC B01D 46/0084; B01D 46/0005; B01D 2279/51; B01D 46/521; B01D 46/0001

(57) ABSTRACT

A filter apparatus and method having a test port member in combination with a filter media. The test port member may be positioned adjacent the outer periphery of the outer peripheral frame and may be attached to a truncated portion of the filter media. One or more scrim layers may be disposed across one or more sides of the test port member and/or the truncated portion of the filter media. A plug may be inserted into a through port of the test port member.

### BACKGROUND

The present embodiments relate to a method and apparatus for a filter, with particular embodiments shown for a filter apparatus and method for use with test ports.

As shown in FIG. 1, in one typical type of clean room construction, an air filter 1 may be positioned in the ceiling of a room to include one or more air filtration or diffuser units. Each of these units may include a hood/housing 2 with a filter 1 positioned across the opening thereof adjacent the clean room surface. Air is forced into the unit and through the filter 1 and/or diffuser 3. The diffuser 3, if used, may be supported upstream of the filter 1 within the unit. The filter 1 may include a frame 4 having two adjacent filter media sections or packs 5a, 5b separated by a centerboard 6 with a test port 6a. If a diffuser 3 is used, the centerboard 6 may have a second port 6b to adjust the diffuser therethrough. As a result of the centerboard 6, the filter 1 requires two separate filter media/packs 5a, 5b and two separate scrim 7a, 7b increasing the cost to manufacture and/or additional assembly labor (e.g. additional centerboard material and adhesive applied to multiple filter packs). Moreover, the centerboard 6 may decrease the airflow uniformity across the filter 1 and may negatively impact the visual appearance of the filter 1 to blend into the rest of the ceiling or surrounding structure. Thus, there is a need for a filter apparatus and method to provide test ports allowing the user to, but is not limited to, reduce assembly labor, material cost, and material waste while increasing airflow uniformity and the visual appearance of the filter.

### SUMMARY

In some embodiments of the invention, for example, a filter apparatus comprising a filter media having an outer periphery, wherein a front face and an a rear face is defined by the outer periphery. In some embodiments, the outer periphery of the filter media includes a truncated portion. In various embodiments, the filter apparatus includes a test port member having a through port extending between a front face and an opposing rear face. In some embodiments, the filter apparatus includes an outer peripheral frame receiving the filter media and the test port member thereby positioning the rear face of each the filter media and the test port member adjacent to each other and correspondingly positioning the front face of each the filter media and the test port member adjacent to each other. In some embodiments, the test port member is received between the outer peripheral frame and the outer periphery truncated portion of the filter media.

In various embodiments, the filter apparatus may include a scrim disposed across the test port member and the filter media. In some embodiments, the scrim includes an opening coaxial with the through port of the test port member. In addition, in some embodiments, the filter apparatus may include a plug received in the opening of the scrim and the through port of the test port member. In various embodiments, the rear face and the front face of the test port member is triangular in shape. In some embodiments, the outer peripheral frame defines an opening, wherein the filter media and the test port member is disposed across the opening. Moreover, in various embodiments, the outer peripheral frame may receive a single filter media.

In some embodiments, a filter apparatus may comprise a filter media having an outer periphery, wherein a front face and a rear face is defined by the outer periphery. In various embodiments, the filter apparatus may include a test port member having a through port extending between a front face and an opposing rear face, wherein the front face and the rear face of the test port member is defined by an outer periphery. In some embodiments, the filter apparatus may include an outer peripheral frame receiving the filter media and the test port member. Moreover, in various embodiments, the test port member may be attached to the outer peripheral frame and the outer periphery of the filter media. In some embodiments, a portion of the outer periphery of the test port member engages the outer periphery of the filter media and an entire remaining portion of the outer periphery of the test port member may be adjacent to the outer peripheral frame.

In various embodiments, the filter apparatus may comprise a scrim layer disposed across at least one of the front face of each the test port member and the filter media and the rear face of each the test port member and the filter media. In some embodiments, the scrim layer may be disposed across the rear face of the test port member and the rear face of the filter media. In addition, in some embodiments, the outer peripheral frame may include one or more frame members defining an opening therein. In some embodiments, the entire remaining portion of the outer periphery of the test port member may engage two nonparallel sides of the one or more frame members. In various embodiments, the filter media may include a truncated corner, wherein the truncated corner engages the portion of the outer periphery of the test port member. In some embodiments, the filter apparatus may comprise a plug received by the through port adjacent the rear face of the test port member. Moreover, in various embodiments, the outer peripheral frame may include one or more frame members defining an opening therein, wherein two adjacent sides of the one or more frame members create an inside corner of the outer peripheral frame. In some embodiments, the inside corner may engage the entire remaining portion of the test port member.

Other embodiments may include a method of manufacturing a filter apparatus comprising the steps of providing a U-shaped portion of an outer peripheral frame at least partially defining an through opening of the filter apparatus. In various embodiments, the method may include the U-shaped portion having a center frame member and a lateral frame member extending from each end of the center frame member. In some embodiments, the method may include providing a test port member having a through port. In addition, in some embodiments, the method may include attaching the test port member to one of the lateral frame members and the center frame member within the U-shaped portion. In various embodiments, the method may include providing a filter media. In some embodiments, the method may include removing a portion of the filter media thereby creating a truncated portion of the filter media. Moreover, in various embodiments, the method may include inserting the truncated portion of the filter media into the U-shaped portion. In some embodiments, the test port member fills the void left of the portion of the filter media removed. In various embodiments, the method may include assembling a remaining portion of the outer peripheral frame to the U-shaped portion.

In various embodiments, the method may include inserting a scrim on at least one of a rear face of each of the test port member and the truncated portion of the filter media and a front face of each of the test port member and the truncated portion of the filter media. In some embodiments, the scrim may be on the rear face of each of the rear face of each of the test port member and the truncated portion of the filter media. In some embodiments, the scrim may be on at least one of the rear face or front face of the truncated portion of the filter media. In some embodiments, the scrim may be on the front face of each of the rear face of each of the test port member and the truncated portion of the filter media. In some embodiments, the method may include inserting a plug into the through port of the test port member. In various embodiments, the test port member may be adhesively attached to each of the center frame member, the lateral frame member, and the truncated portion of the filter media.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein. These and other advantages and features, which characterize the multiple embodiments, are set forth in the claims annexed hereto and form a further part hereof. However, for a better understanding of the embodiments, and of the advantages and objectives attained through its use, reference should be made to the drawings and to the accompanying descriptive matter, in which there are described example embodiments.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of a filter apparatus with a centerboard of the prior art exploded from an embodiment of a hood or air handling unit;

FIG. 2 is a perspective view of one embodiment of a filter apparatus;

FIG. 3 is a rear view of the filter apparatus of FIG. 2;

FIG. 4 is a sectional view taken along line 4-4 of FIG. 3; and

FIG. 5 is an exploded view of the filter apparatus of FIG. 2.

### DETAILED DESCRIPTION

Numerous variations and modifications will be apparent to one of ordinary skill in the art, as will become apparent from the description below. Therefore, the invention is not limited to the specific implementations discussed herein.

The embodiments discussed hereinafter will focus on the implementation of the hereinafter-described techniques for a filter apparatus 10, such as the type that may be used in a clean room environment such as, but is not limited to, surgical rooms, manufacturing facilities (e.g. pharmaceuticals, electronics, etc.) or in other similar applications to control the environmental conditions within the desired area. However, it will be appreciated that the herein-described apparatus and techniques may also be used in connection with other types of filter systems in some embodiments. For example, the herein-described apparatus and techniques may be used in residential, commercial, and/or agricultural applications in some embodiments. Moreover, the herein-described apparatus and techniques may be used in connection with a variety of filter configurations and/or characteristics. Implementation of the herein-described apparatus and techniques within a variety of applications would be well within the abilities of one of ordinary skill in the art having the benefit of the instant disclosure, so the invention is not limited to the clean room implementation discussed herein.

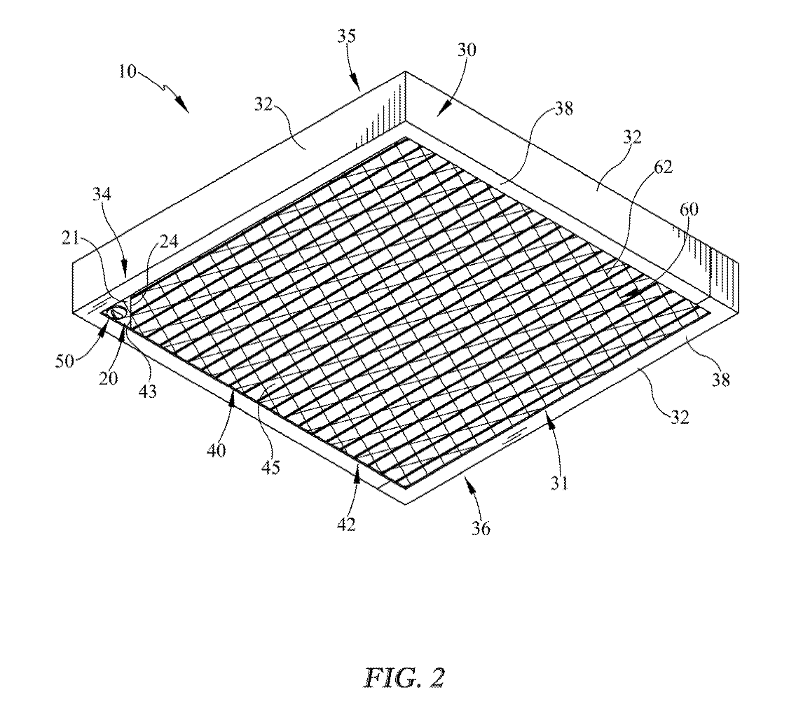

Turning now to the drawings, wherein like numbers denote like parts throughout the several views, FIGS. 2-5 illustrate an example test port member 20 in which the various technologies and techniques described herein may be implemented. At least one test port member 20 may be positioned within one embodiment of the filter apparatus 10. The test port member 20 is positioned along the inside surface of an outer peripheral frame 30 of the filter apparatus 10 and adjacent the filter media/pack 40 (e.g. continuous or single) or filter outer periphery 41. As such, a through opening 31 defined by the filter frame is filled or covered by the test port member 20 and the remaining portion of the through opening 31 is filled or covered by the filter media 40 thereby providing a substantially uninterrupted or uniform airflow through the filter apparatus 10 and/or filter media 40. As alternatively stated the filter media 40 is not divided into multiple filtering areas, or more specifically may not be divided by the test port member 20. Although the test port member 20 of the explanatory embodiment is depicted as being substantially triangular in shape, a variety of other shapes and sizes are contemplated and may be substituted or used in addition to the various depictions. For example, a rectangular or arcuate shape may be used or multiple test port members of different or similar shape may be implemented in the same filter housing and frame. In a some embodiments, the test port member 20 may be aluminum. The test port member may be extruded and/or have a hollow profile in some embodiments. However, a variety of one or more suitable materials may be used. For example, many forms and types of plastic, cardboard or other cellulosic based material, other metal based forms and/or combinations of these options. It should be understood that the test port member 20 may be a variety of constructions, materials, quantities, shapes, sizes, and positions within the filter apparatus and still be within the scope of the description contained herein.

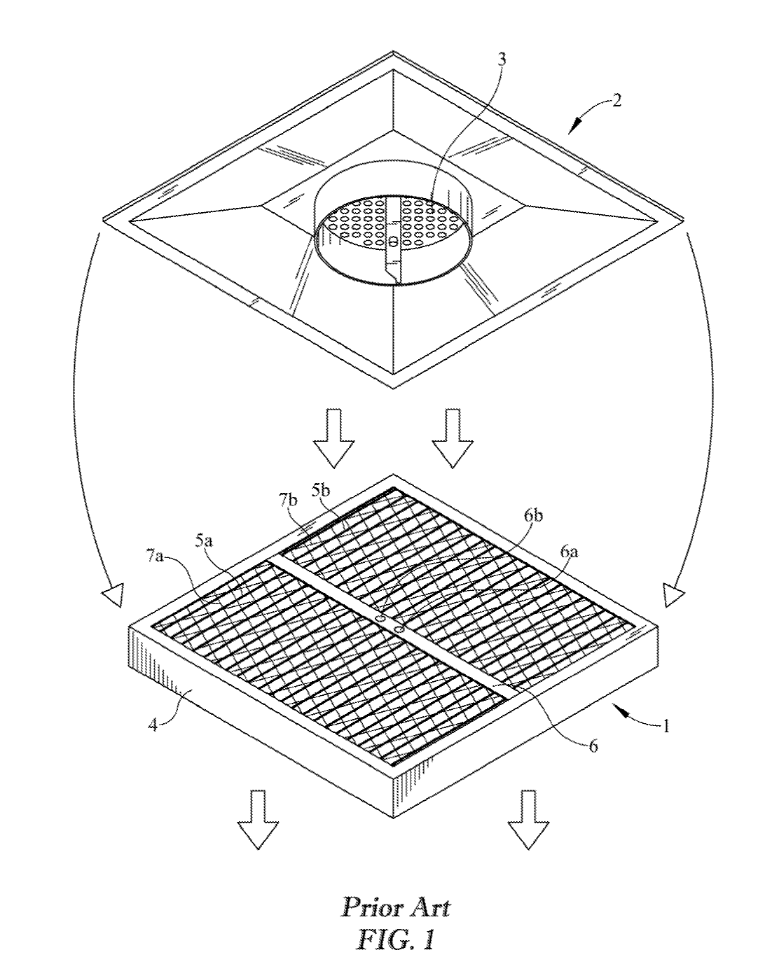

As illustrated, the test port member 20 of the example depicted in FIG. 1 includes one or more through ports or test ports 22 to test the filter efficiency or other characteristic of the filter periodically. The through port 22 may extend through from a rear or downstream face 21 to the front or upstream face 23. As shown, the test port member 20, the rear face 21, and/or front face 23 may be substantially triangular in shape. The through port 22 may receive a plug 50 therein. The plug 50 may be releasably engaged to the through port 22 to gain accessibility through the filter apparatus 10 through the test port opening from the rear face 21 of the test port member 20 when one or more characteristics of the filter apparatus may need to be tested. For example, an aerosol challenge may be sampled on the upstream side of the filter apparatus 10 from the clean room side. In the embodiment shown, the through port 22 may be threaded and correspondingly the plug 50 may be threaded to releasably engage each other. In some embodiments, the plug may include a circumferential flange 52 at a proximal end thereof. The flange may have a diameter and of shape larger than the through port 22 of the test port member 20. The flange 52, if used, when adjacent the rear face 21 or side of the test port member 20 may advantageously, in some embodiments, cover and/or seal the through port 22. Moreover, in some embodiments, the plug may include a tab or other projection/recess 54 (e.g. thumb screw) to assist manual removal/insertion without tools.

The test port member 20 may be received by a variety of outer peripheral frames 30 of the filter apparatus. The outer peripheral frame 30 may include one or more frame members 32 assembled together. The one or more frame members 32 define the through opening 31 therein. The test port member 20 is adjacent the outer periphery of the through opening 31. The test port member 20 may be described as not splitting the through opening 31 of the outer peripheral frame 30. Moreover, the test port member 20 is adjacent the outer peripheral frame 30. A portion or inwardly facing sides 24 of the test port member 20 engages or is adjacent to the outer periphery 41 of the filter media 40 and the remaining portion or outwardly facing sides 25 of the test port member 20 engages or is adjacent to the outer peripheral frame 30. Substantially the entire remaining portion of the outer periphery of the test port member 20 engages one or more portions of the outer peripheral frame 30. In the embodiment shown, the one or more frame members 32 create an inside corner 34 of the outer peripheral frame 30. The inside corner 34 or two adjacent sides receive and engage the test port member 20 (e.g. the outwardly facing sides 25). The sides of one or two frame members 32 may define the corner 34 and each of the nonparallel sides engage the sides or outwardly facing surfaces 25 of the test port member 20. The inside corner 34 may be at angles other than 90 degrees. In some embodiments, the test port member 20 may engage or be adjacent to one side of the outer peripheral frame 30. In the one embodiment shown in the Figures, the outer peripheral frame 30 may be a U-shaped frame member 35 combined with another frame member 36 to define the through opening 31. The test port member 20 may be received within or attach to the U-shaped frame member. The u-shaped frame member 35 may include, in some embodiments, a center frame member 35a and a lateral frame member 35b and 35c projecting from each end of the center frame member 35a. In some embodiments as shown, one or more frame members 32 may include upstream flanges 37 and/or downstream flanges 38. It should be understood that the outer peripheral frame may be a variety of constructions, materials, quantities, shapes, and sizes and still be within the scope of the invention.

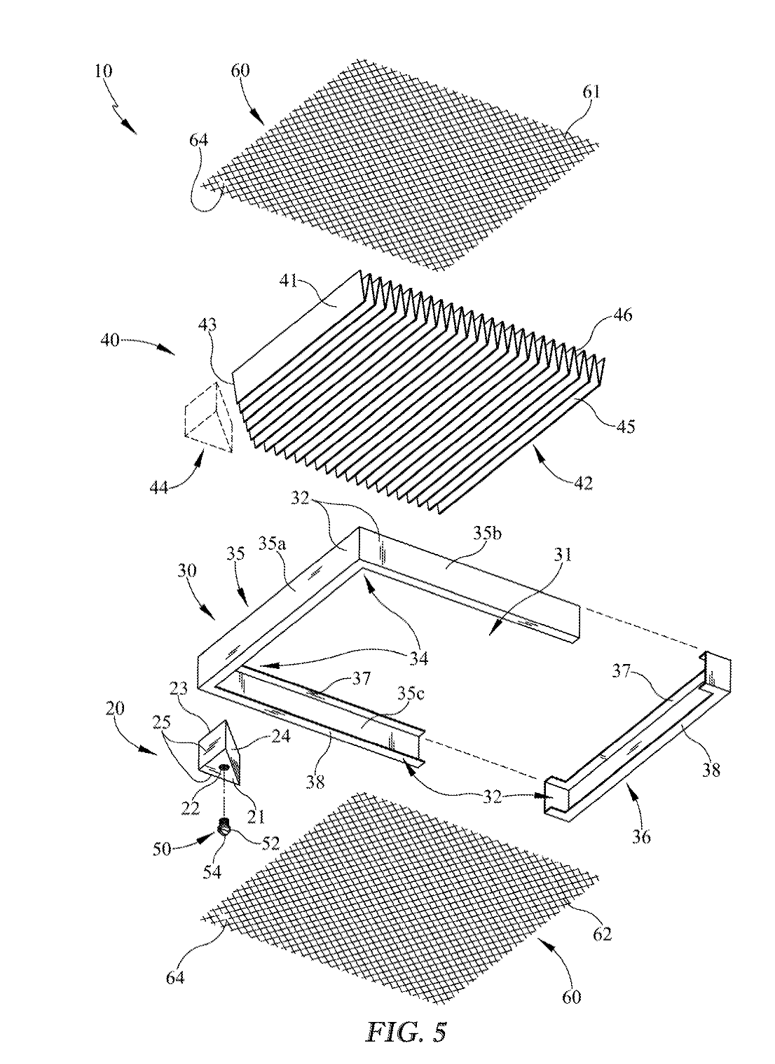

Embodiments of the test port member 20 may be included with a filter media or pack 40 having a variety of characteristics. As shown in the Figures, the embodiment of the air filter media 40 is shown herein for ease of understanding. For example, the test port member 20 may be combined with a variety of filter media to create a variety of air filters. The filter apparatus 10 removes contaminants such as dirt, dust, moisture, salt, carbon, viruses, and/or other contaminants from the air flowing therethrough that may tend to harm the desired environment. Moreover, the filter media/pack or elements 40 may include a pre-filter and a final filter in some embodiments. The filter media 40 may be any suitable type, shape, material, construction, or size. As shown in the embodiment, the filter media 40 may be pleated. The filter media 40 may be a HEPA filter in some embodiments. The filter media 40 may be a variety of materials and/or layers. As shown more clearly in FIG. 5, the filter media 40 may be truncated. The filter media includes a truncated portion 43 and commensurate edge 42, side, or corner or the outer periphery 41 being a verity of shapes. A truncated corner or edge 43 engages or receives the test port member 20. The truncated edge 43 of the filter media may engage or be adjacent to the test port member 20, outer periphery, or inwardly facing side 24 of the test port member. The portion 44 (shown in broken lines in FIG. 5) removed or cut from the filter media 40 may be a variety of shapes to receive or correspond to the size and/or shape of the test port member.

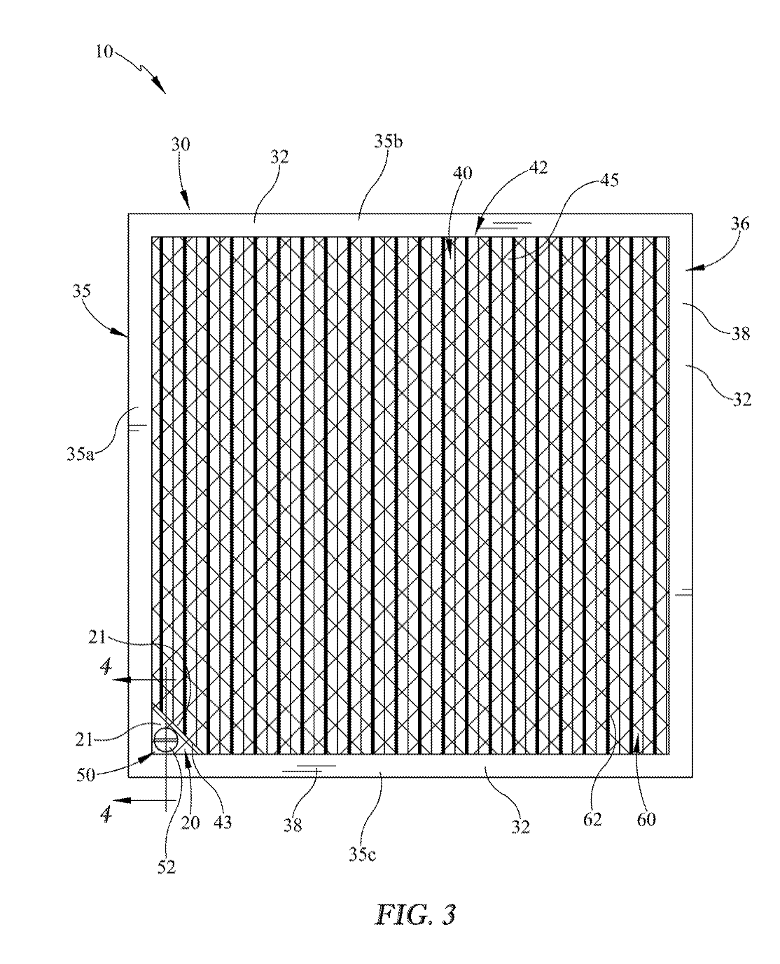

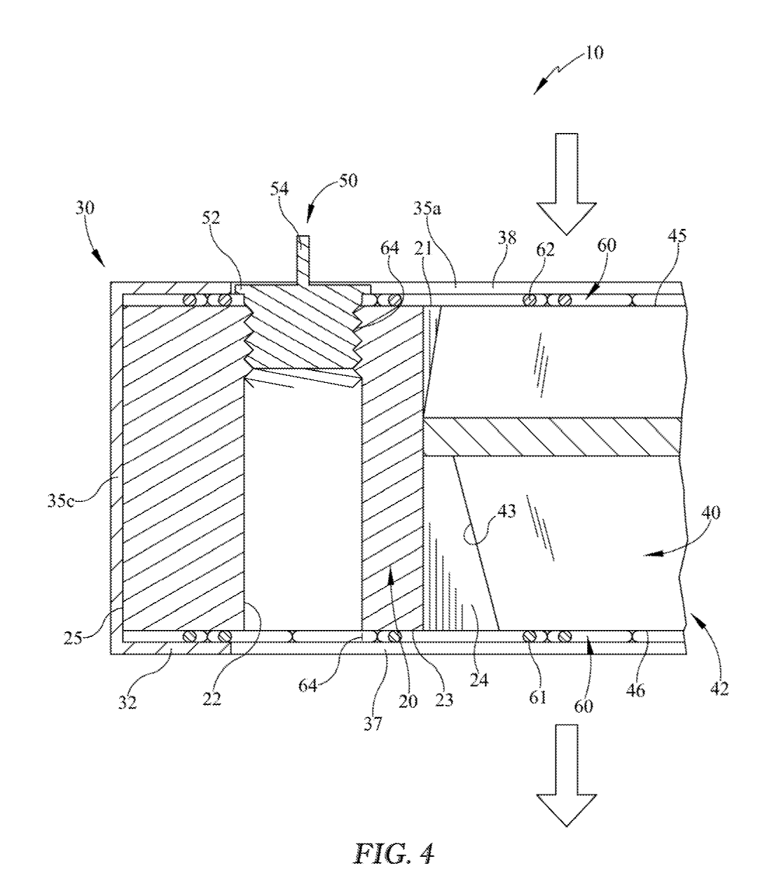

As shown in FIGS. 3 and 4, the test port member 20 and the filter media 40 are in substantially in the same plane when assembled. The rear face 21 of test port member 20 may be adjacent to and may be parallel to a rear face 45 of the filter media. Similarly, the front face 23 of the test port member 20 may be adjacent to and may be parallel to the front face 46 of the filter media 40.

In some embodiments, the filter apparatus 10 may include one or more scrim, mesh, expanded metal, or perforated sheet 60. The outer peripheral frame 30 may receive the one or more scrim layers 60. The scrim 60 may be a powder coated aluminum. However, a variety of materials are contemplated. If used, the scrim layer 60 may be positioned on the upstream and/or downstream side of the filter apparatus 10. In the one embodiment shown in the Figures, the scrim layer 60 is positioned on both the upstream side and downstream side. An upstream scrim layer 61 may be positioned across the front face 23, 46 of each one of the test port member 20 and the filter media 40. A downstream scrim layer 62 may be positioned across the rear face 21, 45 of each one of the test port member 20 and the filter media 40. It should be understood, in some embodiments, the scrim layer 60 may be positioned only over a truncated portion 42 of the filter media 40. If a scrim layer 60 is used on the downstream and/or upstream side of the filter apparatus 10, an opening 64 may extend through the scrim layer 61, 62 and may be coaxial with the through port 22 of the test port member 20 when assembled. One or more scrim openings 64 may receive a portion of the plug 50 when assembled or inserted into the through port 22 of the test port member 20. The flange 52 of the plug 50 may cover up the surrounding scrim material 62, if used, defining the scrim opening 64. It should be understood that the scrim 60 may be a variety of constructions, materials, quantities, shapes, and sizes and still be within the scope of the invention.

In some embodiments, the filter apparatus 10 may be combined with an upstream diffuser 3. A housing 2 containing the diffuser 3 may receive the filter apparatus 10. In some embodiments, the diffuser 3 may be in a preset or predetermined configuration and therefore may not be adjustable when the filter apparatus is received/assembled. However, the diffuser may be adjustable when the filter apparatus is assembled with the housing in some embodiments.

In use, the filter apparatus 10 may be manufactured in a variety of methods and materials. In one embodiment, a portion of or one or more frame members 32 of the outer peripheral frame 30 may partially define the through opening 31 of the filter apparatus 10. In some embodiments, the portion of the outer peripheral frame may constructed in the U-shaped portion 35. The U-shaped portion 35 may include the center frame member 35a and lateral frame members 35b and 35c extending from each end of the center frame member 35a. One or more frame members 32 of the outer peripheral frame may receive or be attached to the test port member, media filter, and/or scrim. One or more of the test port member, media, and scrim may be attached alone or preassembled with each before attaching to the frame members. An adhesive (e.g. polyurethane), if used, may be used to secure one or more structures, sides, portions of the filter apparatus together. The remaining portion or frame member 36 of the outer peripheral frame may be secured to enclose the media filter, one or more scrim (if used), and test port member to define the through opening. In various embodiments, the outer peripheral frame member may be a single piece construction. In some embodiments, the test port member 20 may be attached to the one of the lateral frame members 35b, 35c and the center frame member 35a of the U-shaped portion 35 of the outer peripheral frame 30. In various embodiments, the filter media 40 may be provided in a pre-cut shape (e.g. rectangle) before a portion 44 is removed to create a remaining truncated portion 43 of the filter media 40. The portion 44 may be cut from the remaining truncated portion 43 of the filter media 40 in a shape to match the one or more contact, inwardly facing surfaces 24, or outer periphery surfaces of the test port member 20. In the embodiment shown, the corner 43 of the filter media 40 is cut at about a 45 degree. The test port member 20 may be described as filling the void left when the portion 44 of the filter media is removed. If used, the one or more scrim 60 may be inserted on the upstream and/or downstream sides of the filter apparatus 10. In one embodiment, the scrim 60 may be inserted across the rear face 21, 45 of each of the test port member 20 and the truncated portion 43 of the filter media 40 and/or across the front face 23, 46 of each of the test port member 20 and the truncated portion 43 of the filter media 40. In the embodiment shown, the scrim 60 is positioned on the rear faces 21, 45 and front faces 23, 46 of the test port member 20 and the truncated filter media 43. In some embodiments, a plug 50 may be inserted into the through port 22 of the test port member 20 and scrim 60, if used.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A filter apparatus comprising:
a filter media having an outer periphery, wherein a front face and an a rear face is defined by said outer periphery, and wherein said outer periphery of said filter media includes a truncated portion;
a test port member having a through port extending between a front face and an opposing rear face;
an outer peripheral frame receiving said filter media and said test port member thereby positioning said rear face of each said filter media and said test port member adjacent to each other and correspondingly positioning said front face of each said filter media and said test port member adjacent to each other; and
wherein the test port member is received between said outer peripheral frame and said outer periphery truncated portion of said filter media.

2. The filter apparatus of claim 1 further comprising a scrim disposed across said test port member and said filter media.

3. The filter apparatus of claim 2 wherein said scrim includes an opening coaxial with said through port of said test port member.

4. The filter apparatus of claim 3 further comprising a plug received in said opening of said scrim and said through port of said test port member.

5. The filter apparatus of claim 1 wherein said rear face and said front face of said test port member is triangular in shape.

6. The filter apparatus of claim 1 wherein said outer peripheral frame defines an opening, wherein said filter media and said test port member is disposed across said opening.

7. The filter apparatus of claim 1 wherein said outer peripheral frame receives a single said filter media.

8. A filter apparatus comprising:
a filter media having an outer periphery, wherein a front face and a rear face is defined by said outer periphery;
a test port member having a through port extending between a front face and an opposing rear face, wherein said front face and said rear face of said test port member is defined by an outer periphery;
an outer peripheral frame receiving said filter media and said test port member; and
wherein said test port member is attached to said outer peripheral frame and said outer periphery of said filter media, wherein a portion of said outer periphery of said test port member engages said outer periphery of said filter media and an entire remaining portion of said outer periphery of said test port member is adjacent to said outer peripheral frame.

9. The filter apparatus of claim 8 further comprising a scrim layer disposed across at least one of said front face of each said test port member and said filter media and said rear face of each said test port member and said filter media.

10. The filter apparatus of claim 9 wherein said scrim layer is disposed across said rear face of said test port member and said rear face of said filter media.

11. The filter apparatus of claim 8 wherein said outer peripheral frame includes one or more frame members defining an opening therein, wherein said entire remaining portion of said outer periphery of said test port member engages two nonparallel sides of said one or more frame members.

12. The filter apparatus of claim 8 wherein said filter media includes a truncated corner, wherein said truncated corner engages said portion of said outer periphery of said test port member.

13. The filter apparatus of claim 8 further comprising a plug received by said through port adjacent said rear face of said test port member.

14. The filter apparatus of claim 8 wherein said outer peripheral frame includes one or more frame members defining an opening therein, wherein two adjacent sides of said one or more frame members create an inside corner of said outer peripheral frame, wherein said inside corner engages said entire remaining portion of said test port member.

15. A method of manufacturing a filter apparatus comprising the steps of:
providing a U-shaped portion of an outer peripheral frame at least partially defining an through opening of the filter apparatus, said U-shaped portion having a center frame member and a lateral frame member extending from each end of said center frame member,
providing a test port member having a through port;
attaching said test port member to one of said lateral frame members and said center frame member within said U-shaped portion;
providing a filter media;
removing a portion of said filter media thereby creating a truncated portion of said filter media;
inserting said truncated portion of said filter media into said U-shaped portion, wherein said test port member fills the void left of said portion of said filter media removed; and
assembling a remaining portion of said outer peripheral frame to said U-shaped portion.

16. The method of claim 15 further comprising the step of inserting a scrim on at least one of a rear face of each of said test port member and said truncated portion of said filter media and a front face of each of said test port member and said truncated portion of said filter media.

17. The method of claim 16 wherein said scrim is on said rear face of each of said rear face of each of said test port member and said truncated portion of said filter media.

18. The method of claim 17 wherein said scrim is on said front face of each of said rear face of each of said test port member and said truncated portion of said filter media.

19. The method of claim 15 further comprising a step of inserting a plug into said through port of said test port member.

20. The method of claim 15 wherein said test port member is adhesively attached to each of said center frame member, said lateral frame member, and said truncated portion of said filter media.

21. A filter having a testing port, comprising:
a pleated v-shaped filter media having a front face and a rear face, the pleats extending to a predefined height;
a test port member having a through port extending between a front face and an opposing rear face of the test port;
a plug received within the through port of the test port member, the plug removably affixed within the through port;
a peripheral frame receiving the filter media and the test port member and maintains them in adjacent relationships;
wherein the test port member is retained by the peripheral frame and is positioned between the peripheral frame and a truncated portion of the pleated v-shaped filter media, wherein a first portion of the test port member engages an outer periphery of the filter media and a second portion of the test port member is adjacent to the peripheral frame;
the pleated v-shaped filter media having the truncated portion, the test port adjacent the truncated portion, both the v-shaped filter media and the test port retained within the peripheral frame and forming a rectangular filter.
